(19) United States
(12) Patent Application Publication
(10) Pub. No.: US 2015/0062362 A1
(43) Pub. Date: Mar. 5, 2015

(54) IMAGE PROCESSING SYSTEM AND RELATED METHOD

(71) Applicant: HON HAI PRECISION INDUSTRY CO., LTD., New Taipei (TW)

(72) Inventor: CHIH-HSIANG HU, New Taipei (TW)

(21) Appl. No.: 14/472,803

(22) Filed: Aug. 29, 2014

(30) Foreign Application Priority Data
Aug. 30, 2013 (CN) 2013103852155

(51) Int. Cl. H04N 5/232; H04N 5/235

(52) U.S. Cl. CPC H04N 5/232; H04N 5/235
USPC 348/211.9

(57) ABSTRACT

An image processing system includes a processor and a number of modules. The modules include an information acquiring module, a time determining module, and a data output module. The information acquiring module acquires location information and time information associated with each location information, and acquires location information of the capturing ranges associated with the capturing devices. The time determining module determines the capturing ranges where the electronic device has already entered, and determines first time points that the electronic device enters the determined capturing ranges and second time points that the electronic device leaves the determined capturing ranges. The data output module obtains a plurality of sections from videos captured by the plurality of capturing devices between the first time points and the second time points, and inserting a pre-stored audio into the obtained sections in response to the output request.

### CROSS-REFERENCE TO RELATED APPLICATIONS

This application claims priority to Chinese Patent Application No. 201310385215.5 filed on Aug. 30, 2013 in the China Intellectual Property Office, the contents of which are incorporated by reference herein.

### FIELD

The present disclosure relates to processing systems, and particularly to an image processing system and a method.

### BACKGROUND

It is difficult for one body to capture images of oneself when the body is alone.

### BRIEF DESCRIPTION OF THE DRAWINGS

FIG. 1 illustrates a block diagram of an embodiment of an image processing system.

FIG. 2 is a flowchart of a method of processing images implemented by the image processing system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The present disclosure relates to an image processing system applied between a server and an electronic device, the server controls a number of capturing devices to capture videos, obtains a number of sections from videos captured by the capturing devices based on the location information of the electronic device and the location information of the capturing ranges of the capturing device and time information associated with each location information of the electronic device, and outputs the obtained sections to the electronic device.

Several definitions that apply throughout this disclosure will now be presented.

The term “comprising” means “including, but not necessarily limited to”; it specifically indicates open-ended inclusion or membership in a so-described combination, group, series and the like.

Embodiments of the present disclosure will be described with reference to the accompanying drawings.

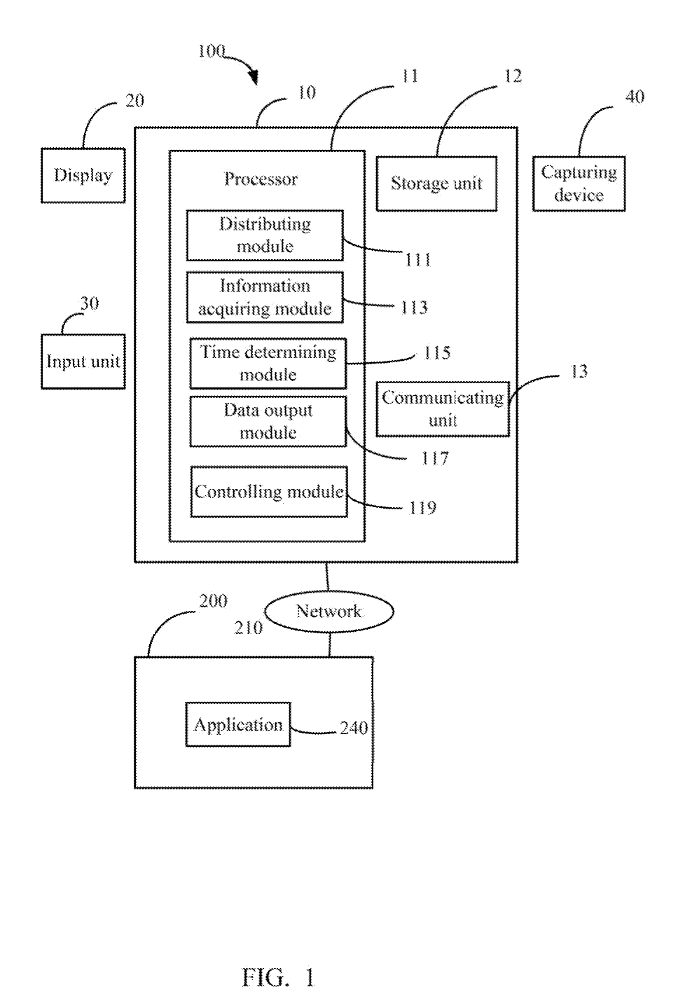

FIG. 1 illustrates an embodiment of an image processing system 100. The image processing system 100 includes a server 10, a display 20, an input unit 30, and a number of capturing devices 40. The input unit 30 is used to receive user input. The display 20 is used to display information. The server 10 includes a processor 11, a storage unit 12, and a communicating unit 13. The server 10 includes a number of modules which are a collection of software instructions stored in the storage unit 12, and executed by the processor 11. The number of modules includes a distributing module 111, an information acquiring module 113, a time determining module 115, and a data output module 117. In one embodiment, the processor 11 can be a central processing unit, a digital signal processor, or a single chip, for example. In one embodiment, the storage unit 12 can be an internal storage system, such as a flash memory, a random access memory (RAM) for temporary storage of information, and/or a read-only memory (ROM) for permanent storage of information. The storage unit 12 can also be a storage system, such as a hard disk, a storage card, or a data storage medium. In at least one embodiment, the storage unit 12 can include two or more storage devices such that one storage device is a memory and the other storage device is a hard drive. The communicating unit 13 communicates with an electronic device 200. Each capturing device 40 has a capturing range. Each capturing range is assigned with location information. Each capturing device 40 captures videos of objects within the capturing range. The storage unit 12 stores the location information of the capturing ranges of the capturing devices 40. In one embodiment, the capturing device 40 is a camera.

The distributing module 111 distributes an identification code for the electronic device 200 in response to an enter request from the input unit 30 when the electronic device 200 enters in a predetermined area. For example, a user enters a park and uses the electronic device 200 to scan a two dimensional code or a barcode displayed on a guidance in the park to acquire a character and to download an application 240. The electronic device 200 sends the character to the server 10 after running the application 240. The server 10 can distribute the character as the identification code of the electronic device 200.

The information acquiring module 113 identifies the electronic device 200 via the identification code, acquires location information of the electronic device 200 in the predetermined area and time information associated with each location information from the electronic device 200 having the identified identification code, and acquires the location information of the capturing ranges associated with the capturing devices 40 in response to an output request. In one embodiment, the time information includes a time point for entering a location and a time point for leaving the location. For example, the electronic device 200 enters the park, periodically acquires location information where the electronic device 200 arrives in the predetermined area and time information associated with each location information, and sends the acquired location information and the time information to the server 10.

The time determining module 115 determines a number of capturing ranges where the electronic device 200 has ever entered according to the acquired location information of the electronic device 200 and the location information of the capturing ranges of the capturing devices 10, and determines a number of first time points that the electronic device 200 has ever entered the number of capturing ranges and a number of second time points that the electronic device 200 has ever leaved the number of capturing ranges according to the time information associated with each location information of the electronic device 200. In one embodiment, there are a number of displays being arranged to locations adjacent to the capturing device 40. When the user enters one of the capturing ranges of the capturing devices 40, the capturing device 40 associated with the capturing ranges transmits the captured video to the display to display, thus the user can view the captured video and adjust the pose accordingly.

In one embodiment, the processor 11 further includes a controlling module 119. The controlling module 119 controls the capturing devices 40 to rotate according to an instruction from the electronic device 200, thereby adjusting the orientation of the capturing devices 40.

The data output module 117 obtains a number of sections between the first time points and the second time points from a number of videos captured by the number of capturing devices 40, and inserts a pre-stored audio into the obtained sections in response to the output request. In one embodiment, the pre-stored audio is inserted into a beginning of the obtained sections. The data output module 117 further synthesizes the number of sections to a video file, and stores the video file to a predetermined storage position.

In another embodiment, the user can view the captured videos on the display 20, and select a section from the captured videos in response to a selection operation on the display 20. The data output module 117 outputs the selected section to the electronic device 200 or another storage device.

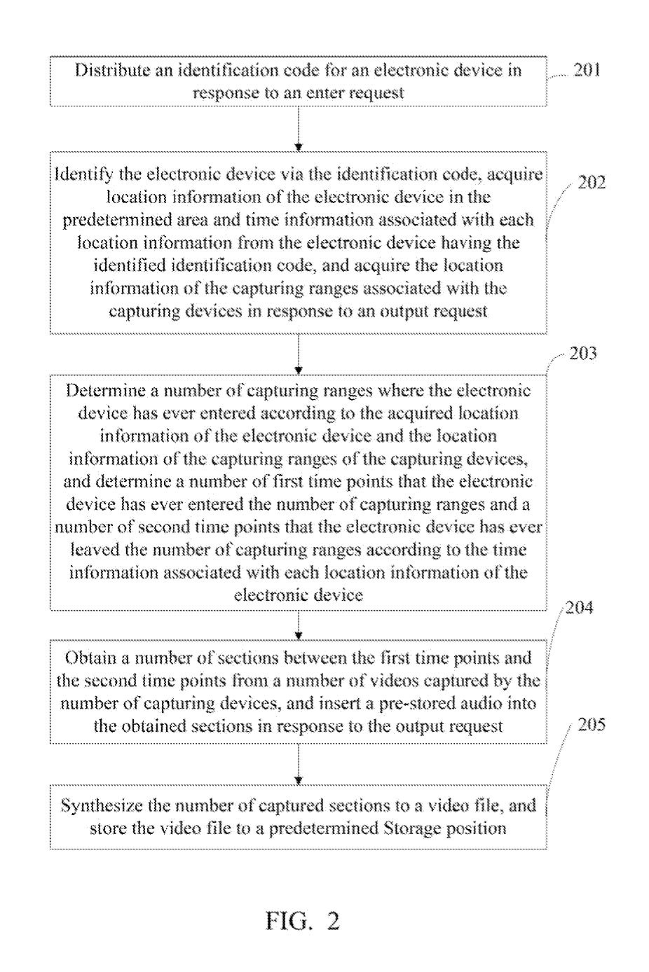

FIG. 2 is a flowchart of a method of processing images implemented by the image processing system of FIG. 1.

In block 201, a distributing module distributes an identification code for an electronic device in response to an enter request when the electronic device enters a predetermined area.

In block 202, an information acquiring module identifies the electronic device via the identification code, acquires location information of the electronic device in the predetermined area and time information associated with each location information from the electronic device having the identified identification code, and acquires the location information of the capturing ranges associated with the capturing devices in response to an output request.

In block 203, a time determining module determines a number of capturing ranges where the electronic device has ever entered according to the acquired location information of the electronic device and the location information of the capturing ranges of the capturing devices, and determines a number of first time points that the electronic device has ever entered the number of capturing ranges and a number of second time points that the electronic device has ever leaved the number of capturing ranges according to the time information associated with each location information of the electronic device.

In block 204, a data output module obtains a number of sections between the first time points and the second time points from a number of videos captured by the number of capturing devices, and inserts a pre-stored audio into the obtained sections in response to the output request.

In block 205, the data output module synthesizes the number of sections to a video file, and stores the video file to a predetermined storage position.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An image processing system comprising:
a storage unit configured to store location information of a plurality of capturing ranges of a number of capturing devices; and
a processor;
a plurality of modules to be executed by the processor, wherein the plurality of modules comprises;
an information acquiring module configured to acquire location information of an electronic device in a predetermined area and time information associated with each location information, and acquire location information of the capturing ranges associated with the capturing devices in response to an output request;
a time determining module configured to determine the capturing ranges where the electronic device has ever entered according to the acquired location information of the electronic device and the location information of the capturing ranges of the capturing devices, and determine a plurality of first time points that the electronic device has ever entered the determined capturing ranges and a plurality of second time points that the electronic device has ever leaved the determined capturing ranges according to the time information associated with each location information of the electronic device; and
a data output module configured to obtain a plurality of sections between the first time points and the second time points from a plurality of videos captured by the plurality of capturing devices, and insert a pre-stored audio into the obtained sections in response to the output request.

2. The image processing system as described in claim 1, wherein the plurality of modules further comprises:
a controlling module configured to control the capturing devices to rotate according to an instruction from the electronic device to adjust the orientation of the capturing devices.

3. The image processing system as described in claim 1, wherein the plurality of module further comprises:
a distributing module configured to distribute an identification code for the electronic device in response to an enter request when the electronic device enters the predetermined area; and
the information acquiring module further configured to identify the electronic device via the identification code, acquire location information of the electronic device in the predetermined area and time information associated with each location information from the electronic device having the identified identification code, and acquire the location information of the capturing ranges associated with the capturing devices in response to the output request.

4. The image processing system as described in claim 1, wherein the data output module is further configured to synthesize the plurality of sections to a video file, and store the video file to a predetermined storage position.

5. An image processing method comprising:
storing location information of a plurality of capturing ranges of a number of capturing devices;
acquiring location information of an electronic device in a predetermined area and time information associated with each location information, and acquiring location information of the capturing ranges associated with the capturing devices in response to an output request;
determining the capturing ranges where the electronic device has ever entered according to the acquired location information of the electronic device and the location information of the capturing ranges of the capturing devices, and determining a plurality of first time points that the electronic device has ever entered the determined capturing ranges and a plurality of second time points that the electronic device has ever leaved the determined capturing ranges according to the time information associated with each location information of the electronic device; and
obtaining a plurality of sections between the first time points and the second time points from a plurality of videos captured by the plurality of capturing devices, and inserting a pre-stored audio into the obtained sections in response to the output request.

6. The image processing method as described in claim 5, further comprising:
controlling the capturing devices to rotate according to an instruction from the electronic device to adjust the orientation of the capturing devices.

7. The image processing method as described in claim 5, further comprising:
distributing an identification code for the electronic device in response to an enter request when the electronic device enters the predetermined area; and
identifying the electronic device via the identification code, acquiring location information of the electronic device in the predetermined area and time information associated with each location information from the electronic device having the identified identification code, and acquiring the location information of the capturing ranges associated with the capturing devices in response to the output request.

8. The image processing method as described in claim 5, further comprising:
synthesizing the plurality of sections to a video file, and storing the video file to a predetermined storage position.

9. A non-transitory storage medium having stored thereon instructions that, when executed by at least one processor of a computing device, causes the least one processor to execute instructions of a method for automatically testing signal integrity of an electronic product, the method comprising:
storing location information of a plurality of capturing ranges of a number of capturing devices;
acquiring location information of an electronic device in a predetermined area and time information associated with each location information, and acquiring location information of the capturing ranges associated with the capturing devices in response to an output request;
determining the capturing ranges where the electronic device has ever entered according to the acquired location information of the electronic device and the location information of the capturing ranges of the capturing devices, and determining a plurality of first time points that the electronic device has ever entered the determined capturing ranges and a plurality of second time points that the electronic device has ever leaved the determined capturing ranges according to the time information associated with each location information of the electronic device; and
obtaining a plurality of sections from a plurality of videos captured by the plurality of capturing devices between the first time points and the second time points, and inserting a pre-stored audio into the obtained sections in response to the output request.

10. The non-transitory storage medium as described in claim 9, wherein the method further comprises:
controlling the capturing devices to rotate according to an instruction from the electronic device to adjust the orientation of the capturing devices.

11. The non-transitory storage medium as described in claim 9, wherein the method further comprises:
distributing an identification code for the electronic device in response to an enter request when the electronic device enters the predetermined area; and
identifying the electronic device via the identification code, acquiring location information of the electronic device in the predetermined area and time information associated with each location information from the electronic device having the identified identification code, and acquiring the location information of the capturing ranges associated with the capturing devices in response to the output request.

12. The non-transitory storage medium as described in claim 9, wherein the method further comprises:
synthesizing the plurality of sections to a video file, and storing the video file to a predetermined storage position.
